(19) United States
(12) Patent Application Publication
(10) Pub. No.: US 2011/0265706 A1
(43) Pub. Date: Nov. 3, 2011

(54) Wearable Temperature Sensor

(75) Inventor: Jeffrey Steven Nicholls, Berkshire (GB)

(73) Assignees: Philip George Randle, Surrey (GB); Gary Russell Howes, London (GB)

(21) Appl. No.: 12/994,992

(22) PCT Filed: May 29, 2009
(86) PCT No.: PCT/GB2009/050592

§ 371 Date: Feb. 21, 2011

(30) Foreign Application Priority Data
May 29, 2008 (GB) 0809753.7

(51) Int. Cl. G01K 1/02

(52) U.S. Cl. 116/201; 116/216

(57) ABSTRACT

A wearable temperature-sensing apparatus for measuring an ambient environmental temperature or a surface temperature of an object. The sensing apparatus comprises a fail-safe audible indicator for indicating to a user a magnitude of the temperature.

This invention relates to temperature-sensing apparatus for personnel in hazardous environments. It is particularly relevant in the field of safety/protective equipment used in fire fighting.

The protective equipment provided to the modern fire-fighter is of a very high standard. Typical personal protective equipment includes clothing, such as heat-proof leggings, tunic, gloves, flash hood (a heat resistant balaclava) and boots. Helmets, often incorporating a protective visor or face shield are the norm. The fire-fighter may also carry a self-contained breathing apparatus (SCBA). All of this equipment is necessary to protect the individual from the various hazards of heat, debris and noxious gases encountered in the course of duty. As a result total coverage from head to toe is not uncommon as the fire-fighter approaches a fire.

However, perhaps the most important factor in assuring the safety of fire-fighting personnel is the extensive training they receive. In particular, fire-fighters are taught to be constantly aware of their surroundings and to continually re-assess dangerous situations.

According to an aspect of the current invention, there is provided a wearable temperature-sensing apparatus for measuring an ambient environmental temperature or a surface temperature of an object, the sensing apparatus comprising a fail-safe audible indicator for indicating to a user a magnitude of the temperature.

The inventors have realized that the extent of protection provided to the modern fire-fighter is such that there is a risk that his sensory perception of the immediate environment is compromised. They have further recognized the danger inherent in such isolation. A fire-fighter who is so completely insulated from the surroundings has no way of judging potentially life-threatening temperatures. Thus, although advanced protective clothing may enable the fire-fighter to operate in more extreme environments, it can also prevent him noticing that the temperature has risen beyond a safe level. By the time the temperature inside the clothing has risen perceptibly, the fire-fighter may have progressed far into a burning building. In the subsequent time taken to escape, serious injury may occur. Similarly, the high level of insulation of the protective clothing may be associated with a large heat capacity of the materials. As a result, the clothing will not only be slow to heat up, but similarly slow to cool down. The accumulated heat in the protective clothing means that even escaping from the hot environment may not immediately make the fire-fighter safe.

The temperature-sensing apparatus of the invention can provide the fire-fighter with a constant indicator of the temperature in his immediate surroundings, increasing his awareness and compensating for the loss of sensitivity caused by the protective equipment. Safety is further enhanced by the provision of a fail-safe audible indicator to indicate the temperature value. In this context, “fail-safe” means that the audible indicator is designed so that the user is immediately aware of a failure of the temperature sensor. This avoids a potentially dangerous situation in which the sensor malfunctions (stops providing temperature measurements) unbeknownst to the user.

Preferably the temperature-sensing apparatus further comprises a display for graphically displaying the magnitude of the temperature.

A display may augment the audible indicator by offering way of conveying the temperature value more precisely. It can also be viewed as a secondary gauge, should the audible indicator itself fail.

The temperature-sensing apparatus may further comprise recording means adapted to record the magnitude of the temperature.

A recording of the history of temperature experienced can be useful in later analyzing or predicting an individual's performance—for example their response to heat stress at different temperature levels. It might also be beneficial in investigation of the source or cause of a fire.

The recording means may be adapted to record a maximum magnitude of the temperature.

The maximum temperature to which the fire fighter has been exposed can be of particular relevance in investigation of a fire incident after the event.

The fail-safe audible indicator may be adapted to generate an audible tone and modulate a characteristic of the tone in response to the magnitude of the temperature so as to indicate the magnitude to the user.

Continuous (or continual, repetitive) generation of a tone is one straightforward way of achieving fail-safe functionality. If the tone stops, the user knows that the device has failed for some reason. An audible feature of the tone is modulated to indicate the measured temperature.

The characteristic of the audible tone may be at least one of: a pitch of the tone and a frequency of repetition of the tone.

For example, the tone (or sequence of tones) may be designed to become more intrusive (by changing pitch or repetition) as the temperature rises, to indicate increasing levels of danger.

The temperature-sensing apparatus may further comprise a receiver, operable in a training mode to receive simulated temperature data, the apparatus being operable in the training mode to indicate to the user the magnitude of the simulated temperature instead of the measured temperature.

A device of this kind can be used to enhance the training of fire-fighting personnel. By making the device responsive to a simulated temperature, the fire-fighter is taught to rely not only on a physical sensation of temperature (which may be compromised by protective clothing) but on the audible temperature indicator. Furthermore, this can be achieved in a safe environment—it is not necessary to elevate the temperature in order to practice using the device. The responses of the trainee fire-fighter to (simulated) events can therefore be evaluated and improved without risk to life.

According to another aspect of the invention, there is provided a heat resistant glove comprising the temperature sensing apparatus described above.

Embedding the temperature sensor in a glove results is a particularly beneficial wearable sensor. Fire-fighters are already trained to test surfaces (such as walls or doors) for heat using their gloved hands. By adding the temperature sensor to the glove, this existing practice can be continued.

According to still another aspect of the invention, there is provided an apparatus for use in a method of safely training personnel to operate in a hazardous environment, the apparatus comprising: a transmitter adapted to transmit simulated temperature data; and the temperature-sensing apparatus with receiver described above.

According to yet another aspect of the invention, there is provided a method of sensing temperature comprising: measuring an ambient environmental temperature or a surface temperature of an object; and indicating a magnitude of the temperature to a user by means of a fail-safe audible indicator.

According to yet another aspect of the current invention, there is provided a method of safely training a person to operate in a hazardous environment, the method comprising: transmitting simulated temperature data; receiving the simulated temperature data; and indicating a magnitude of the simulated temperature to the person by means of a fail-safe audible indicator.

The invention will now be described by way of example with reference to the accompanying drawings, in which:

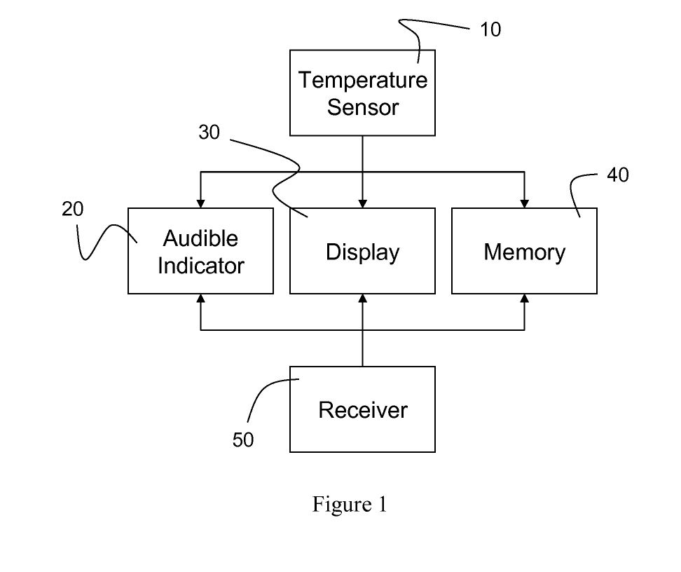

FIG. 1 shows a block diagram of an apparatus according to an embodiment;

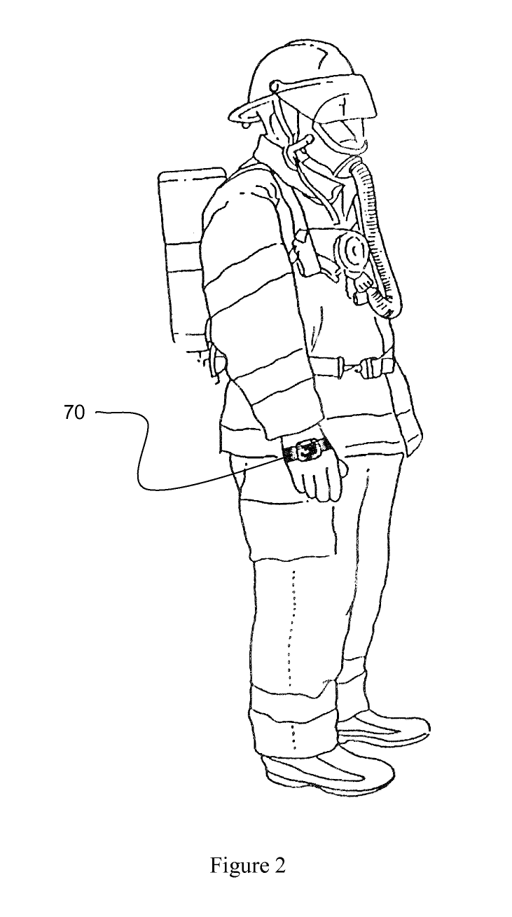

FIG. 2 is an illustration of a fire-fighter wearing an apparatus according to an embodiment

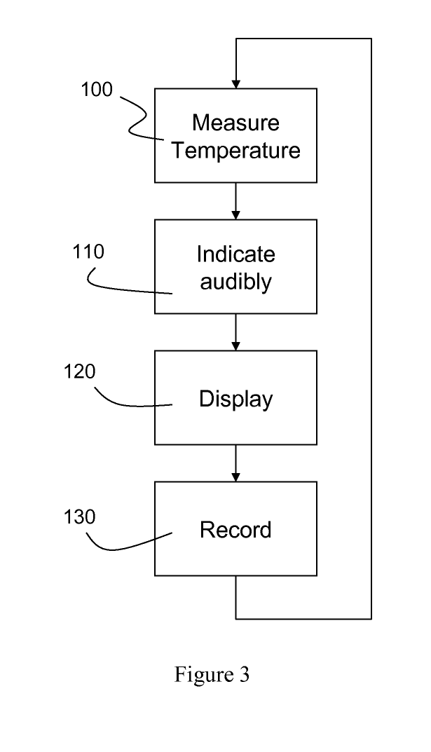

FIG. 3 shows a flowchart of a method according to an embodiment;

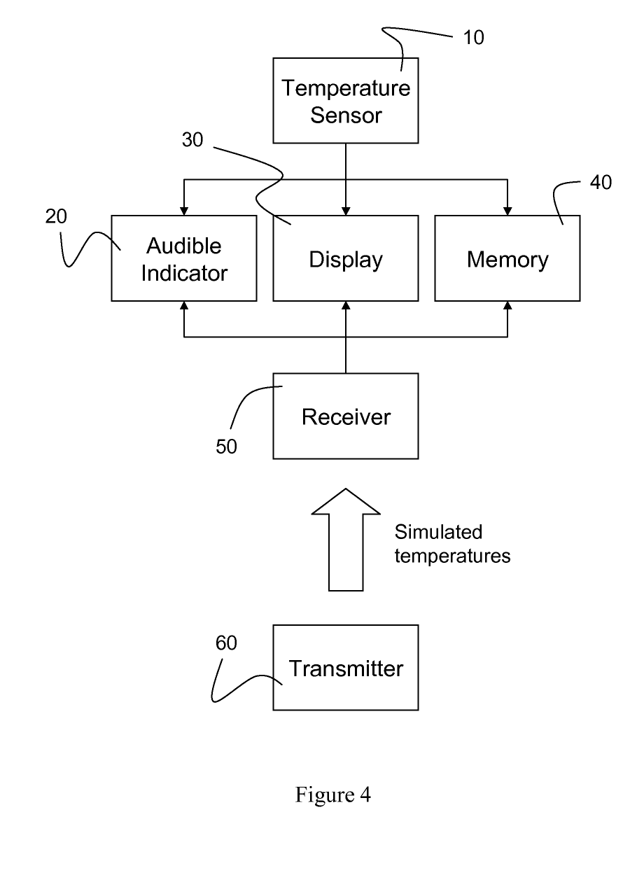

FIG. 4 shows a block diagram of a training system according to an embodiment; and

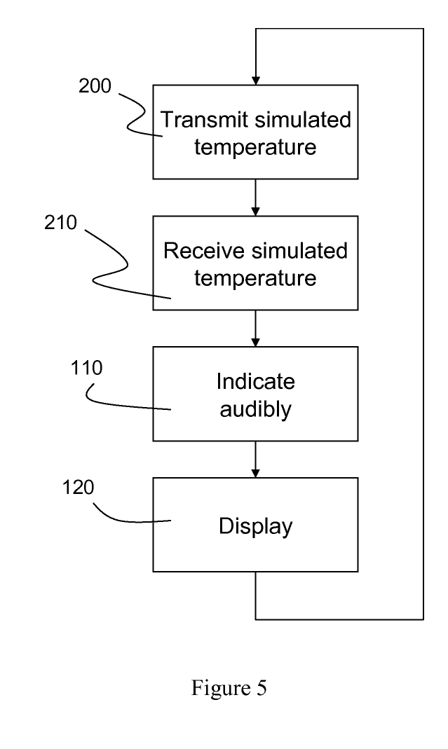

FIG. 5 shows a flowchart of a training method according to an embodiment.

Knowledge of ambient and local temperature is essential to a fire-fighter. Not only is there an obvious correlation between temperature and the risk of burn-injury, but in certain situations the levels and dynamics of temperature can provide an advance warning of the extremely hazardous phenomena of back-draft and flash-over.

In the past, a fire-fighter could rely on exposed or partially exposed areas of skin (such as around the ears and face) to sense the heat of a fire and changes in temperature. Now, with the advent of full body cover, including a flash-hood, this link with the immediate environment is broken. The current invention restores this link and thus reduces the risk that full body cover gives the fire fighter a false sense of security.

The block diagram of FIG. 1 shows a temperature sensing apparatus according to an embodiment of the current invention. The device incorporates a temperature sensor 10 and an audible indicator 20, for indicating to the user the magnitude of the temperature measured by the sensor 10.

The temperature sensor may be one of a number of types, including thermistors, thermocouples, fibre-optical sensors and infrared sensors. As will be apparent to one skilled in the art, design considerations such as the high temperatures to which the device will be exposed will limit the choice. Thermocouples, for example, may be especially appropriate, since they combine sensitivity, simplicity and high temperature tolerance. Furthermore, a thermocouple is likely to be of lower cost than many alternatives, such as an infra-red temperature sensor.

The audible indicator 20 may be implemented by means of a speaker or by a remote (wired or wireless) earpiece. The use of an earpiece avoids the potential problem that protective clothing worn by the fire-fighter could muffle the sound of a speaker worn externally.

The sound generated by the audible indicator 20 should be loud enough and designed to be heard in the noisy environment of a fire. A fail-safe indication can be achieved in a number of ways. For example, a sequence of beeps can be used to indicate the temperature. Higher temperatures would correspond to a faster rate of beeping. Equally, a continuous tone could be modulated in frequency or volume to communicate the same information. In a more complex multi-tone indication, a series of tones of different frequencies could be successively superimposed as consecutively higher temperature thresholds are reached. In each case the indication is “fail-safe” because, should the temperature sensor cease to provide temperature measurements, the tone or tones will stop—alerting the user to the problem.

Optionally, the device may also include a display 30, such as a digital display, which allows the user to see the temperature value as well as hearing the audible indication. The display 30 could be, for example, a light-emitting diode (LED) display, which displays numerical data. The availability of a visual read-out of the temperature level provides a degree of redundancy, should the audible indicator 20 fail for any reason.

Also optional is a memory 40, which can be used to record the temperature experienced by the apparatus (and fire-fighter) while in use, to enable later analysis. Any suitable data storage element can be used as the memory 40, such as flash memory. The recorded temperature data would typically be uploaded to a computer to perform the analysis. Analysis of the temperature history may be relevant, for example, in investigation of the cause and/or characteristics of a fire as well as providing valuable information to manufacturers of fire-protective equipment.

In one embodiment, the maximum temperature experienced by the fire fighter is stored in the memory 40 and displayed on the display 30. This read-out of maximum temperature can be a useful aid in investigation of the fire incident immediately after the event. The use of the graphical display 30 eliminates the need to connect to a computer to access the maximum temperature data.

Also pictured in FIG. 1 is a receiver 50 for receiving synthetic temperature data. This can be used in a training mode to override the actual sensed temperature values detected by the sensor. The training mode will be described in more detail below.

The device of FIG. 1 can be powered by a small battery, such as a watch-battery (not shown).

FIG. 2 is an example of how an embodiment of the wearable temperature sensing device 70 may be worn in use by a fire-fighter. The use of a wrist-strap or integration of the device into a fire-glove can be beneficial since it allows the fire-fighter to test the temperature of a surface by holding the sensor in contact with it. Thus, as well as constantly providing an indication of ambient (air) temperature, the device can also provide specific measurements of objects in the environment. Of course, if the sensor 10 is a non-contact type sensor (for example, an infra-red sensor) then it will not be necessary to hold it in contact with an object of interest in order to measure surface temperature.

As well as measuring surface-temperatures, the wearing of the device 70 on the hand also enables the fire-fighter to test open spaces before entering them fully. For example, the hand can be held out into a doorway or around a corner to test the temperature. Then, in the worst case, only the hand will be at risk of burning if the room is too hot.

FIG. 3 shows a method of sensing temperature with the apparatus described above. At step 100, the temperature sensor 10 measures the ambient or surface temperature of interest. At step 110 the audible indicator 20 emits a tone to indicate the magnitude of the sensed temperature to the user.

Optionally, at step 120, the magnitude is also shown on the display 30.

Also, optionally, if memory 40 is provided, the magnitude is recorded to it. The magnitude may be recorded continuously or periodically. Alternatively, only certain magnitudes of interest may be selectively recorded—for example, the maximum temperature encountered in a predetermined period could be stored.

FIG. 4 shows the temperature sensing apparatus illustrated in FIG. 1, together with a transmitter 60, which is operable to transmit simulated or synthetic temperature values to the apparatus. This system can be used in training—whether training fire-fighters to use the wearable apparatus, or simply training them in standard operating procedures for fire-fighting, in a safe environment.

Such a training method will now be described with reference to FIG. 5. At step 200 the transmitter 60 transmits simulated temperature data to the wearable apparatus. This is received, in step 210, by the receiver 50 of the apparatus. The received synthetic temperature data is then conveyed to the wearer, in step 110, by means of the audible indicator 20. If the wearable apparatus has a display 30, the synthetic value of temperature is displayed (step 120).

In one embodiment, the wearable apparatus may have a training mode, in which it activates the receiver 50, ready to receive transmitted synthetic temperature values. Until such values are received, it functions normally, audibly indicating and displaying real sensed temperature values.

The transmitter will typically be controlled by an instructor. When the instructor wishes to simulate artificial environmental conditions, the transmitter can be used to transmit a temperature value of the instructor's selection. When the wearable apparatus receives this synthetic value, it indicates it in preference to the actual sensed magnitude. In other words, a transmitted temperature value may over-ride the sensed value. In an alternative embodiment, the maximum of the two temperatures (sensed and synthetic) may be indicated/displayed.

In this way, a trainee fire-fighter wearing the apparatus can be trained to respond in appropriate ways, for example, to given temperatures or to sudden changes in temperature. By communicating these temperatures to the fire-fighter using the same apparatus used in a real fire, the fire-fighter is able to practise in the most realistic way possible. At the same time, by providing synthetic data, the training can be accomplished without the need to control actual temperatures and, more importantly, without exposing the trainee to potentially dangerous high temperatures or fire.

Various modifications to the methods and apparatus described above will be apparent to those skilled in the art.

Although the invention has been described with specific reference to a fire-fighting application, the apparatus and methods described are also applicable in other fields where personnel are required to operate in hazardous environments involving extremes of temperature. For example, the invention would be applicable to personnel operating in cold environments such as refrigerated storage.

1. A wearable temperature-sensing apparatus for measuring an ambient environmental temperature or a surface temperature of an object, the sensing apparatus comprising a fail-safe audible indicator for indicating to a user a magnitude of the temperature.

2. The temperature-sensing apparatus of claim 1, further comprising a display for graphically displaying the magnitude of the temperature.

3. The temperature-sensing apparatus of claim 1, further comprising recording means adapted to record the magnitude of the temperature.

4. The temperature-sensing apparatus of claim 3, wherein the recording means is further adapted to record a maximum magnitude of the temperature.

5. The temperature-sensing apparatus of claim 1, wherein the fail-safe audible indicator is adapted to generate an audible tone and modulate a characteristic of the tone in response to the magnitude of the temperature so as to indicate the magnitude to the user.

6. The temperature-sensing apparatus of claim 5, wherein the characteristic of the audible tone is at least one of: a pitch of the tone and a frequency of repetition of the tone.

7. The temperature-sensing apparatus of claim 1, further comprising a receiver, operable in a training mode to receive simulated temperature data, the apparatus being operable in the training mode to indicate to the user the magnitude of the simulated temperature instead of the measured temperature.

8. A heat resistant glove comprising the temperature sensing apparatus of claim 1.

9. (canceled)

10. An apparatus for use in a method of safely training personnel to operate in a hazardous environment, the apparatus comprising:
a transmitter adapted to transmit simulated temperature data; and
the temperature-sensing apparatus of claim 7.

11. A method of sensing temperature comprising:
measuring an ambient environmental temperature or a surface temperature of an object; and
indicating a magnitude of the temperature to a user by means of a fail-safe audible indicator.

12. A method for safely training a person to operate in a hazardous environment, the method comprising:
transmitting simulated temperature data;
receiving the simulated temperature data; and
indicating a magnitude of the simulated temperature to the person by means of a fail-safe audible indicator.
